(19) United States
(12) Patent Application Publication
(10) Pub. No.: US 2022/0404951 A1
(43) Pub. Date: Dec. 22, 2022

(54) Focus Management Method Applied to Electronic Device and Electronic Device

(71) Applicant: Huawei Technologies Co., Ltd., Shenzhen (CN)

(72) Inventor: Yanhua Zhao, Shenzhen (CN)

(21) Appl. No.: 17/638,471

(22) PCT Filed: Aug. 27, 2020
(86) PCT No.: PCT/CN2020/111877

§ 371 Date: Feb. 25, 2022

(30) Foreign Application Priority Data
Aug. 30, 2019 (CN) 201910818465.0

(51) Int. Cl. G06F 3/04817; G06F 9/451

(52) U.S. Cl. CPC G06F 3/04817; G06F 9/451

(57) ABSTRACT

A method comprises attempting to detect, using a display interface container of a display interface, a card container selection, wherein the display interface container comprises one or more card containers having one or more cards, detecting, using the card container selection and based on a current focus, a card container selection event generated upon either an up arrow button pressing event or a down arrow button pressing event, determining, according to the card container selection event, a target card container in which a target focus is located, and selecting a target focus in the target card container according to a focus up or a focus down movement algorithm.

This application claims priority to Chinese Patent Application No. 201910818465.0, filed with the China National Intellectual Property Administration on Aug. 30, 2019 and entitled “FOCUS MANAGEMENT METHOD APPLIED TO ELECTRONIC DEVICE AND ELECTRONIC DEVICE”, which is incorporated herein by reference in its entirety.

### TECHNICAL Field

This application relates to the field of terminal technologies, and in particular, to a focus management method applied to an electronic device and an electronic device.

### BACKGROUND

With the rapid development of smart TVs, applications (application, App) applied to smart TVs are becoming more abundant. Many apps can display various content (such as poster pictures and cards) on a display interface of the smart TV Among a plurality of pieces of displayed content on the display interface, a display effect of one piece of displayed content is different from a display effect of displayed content at another position, and this piece of displayed content is referred to as a focus. For example, a border of displayed content corresponding to a focus may be highlighted, so as to distinguish the displayed content from other displayed content. A user may control the focus to move by using a remote control, for example, by pressing an up arrow button of the remote control to move the focus upward, or by pressing a right arrow button of the remote control to move the focus rightward. The App can move a focus position based on a button pressing operation of the user.

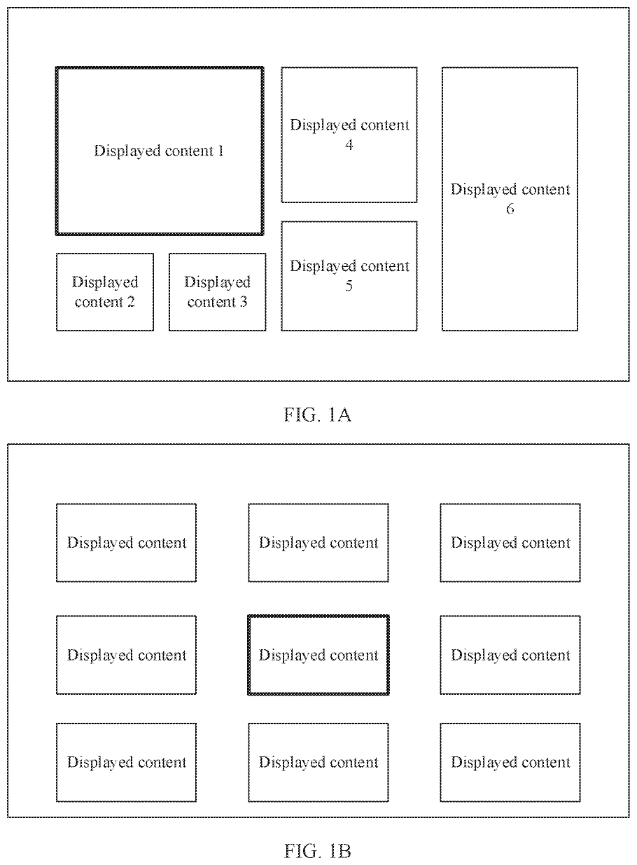

Currently, for most App display interface, there are a relatively small quantity of pieces of displayed content, with fixed positions, or there are a relatively large quantity of pieces of displayed content, but with a single display style. For example, as shown in FIG. 1A, the display interface includes displayed content 1, displayed content 2, displayed content 3, displayed content 4, displayed content 5, and displayed content 6, and positions of the six pieces of displayed content are fixed. For example, as shown in FIG. 1B, the display interface displays nine pieces of displayed content in a nine-square grid style, and displayed content at each position may not be fixed.

A focus management method for such a display interface with a relatively simple layout is relatively simple. For example, an Android-based App may use a focus management mechanism native to Android. In the focus management mechanism native to Android, each piece of displayed content is used as one unit for focus management. When a piece of displayed content is used as the current focus, a rule can be defined for focus movement after the displayed content receives a button pressing operation of the user.

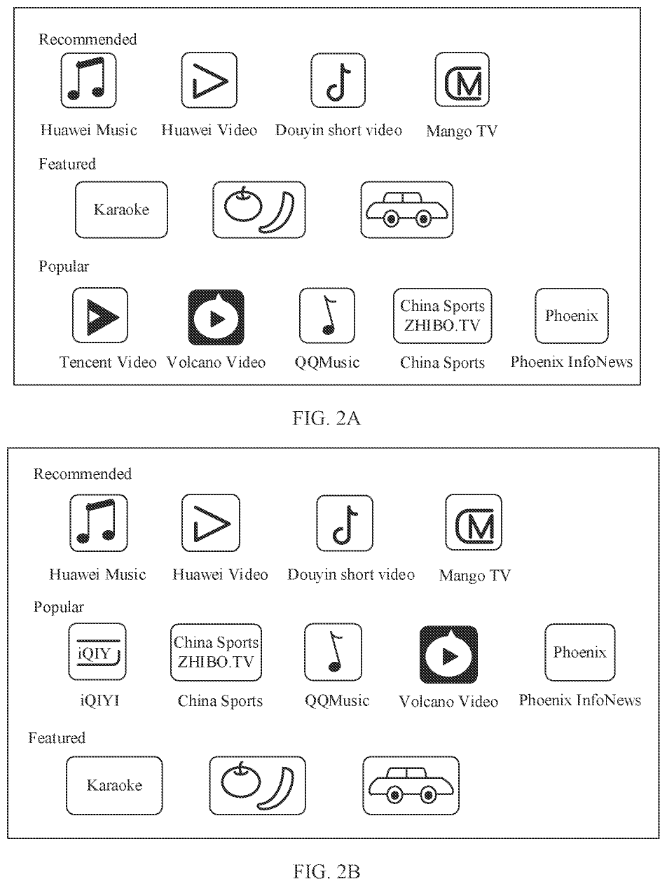

However, for some App display interfaces, there are a relatively large quantity of pieces of content, with various display forms. For example, for a display interface of Huawei AppGallery, there are a relatively large quantity of pieces of displayed content, with various display forms, and content displayed at each position is not fixed. For example, as shown in FIG. 2A and FIG. 2B, the display interface includes displayed content such as a recommended category, a featured category, and a popular category. Displayed content of the recommended category and the popular category are in a form of pictures and captions, and displayed content of the featured category is in a form of pictures. After the display interface is refreshed each time, a position of the displayed content is not fixed. For example, after an App display interface is refreshed from an interface shown in FIG. 2A to an interface shown in FIG. 2B, the displayed content of the popular category is moved onto the displayed content of the feature category, and both content and an arrangement order of the displayed content of the popular category are changed.

For such a display interface with a relatively large quantity of pieces of displayed content and a relatively complex layout, the foregoing simple focus management method is not applicable. If each piece of displayed content is used as one unit for management, system memory consumption is relatively large in a case in which there are a large quantity of pieces of displayed content, with positions not fixed, on the display interface. In addition, if a focus movement rule needs to be modified, it needs to be modified for units one by one, which is not conducive to maintenance and extension. There is a need for a focus management method applicable to a display interface with a relatively large quantity of pieces of displayed content and a relatively complex layout.

### SUMMARY

Embodiments of this application provide a focus management method applied to an electronic device and an electronic device, which are applicable to a display interface with a relatively large quantity of displayed content and a relatively complex layout, to reduce system memory consumption, and facilitate maintenance and expansion.

According to a first aspect, an embodiment of this application provides a focus management method applied to an electronic device. A display interface of the electronic device includes one display interface container, the display interface container includes one or more card containers, and each card container includes one or more cards. The focus management method may include: starting a card container selection listening by using the display interface container of the display interface as a unit, to monitor whether a card container selection event is received; after the card container selection event is received by means of listening, determining a target card container according to the card container selection event; and determining a target focus in the target card container according to a focus up/down movement algorithm. The card container selection event is generated based on a current focus upon an up arrow button pressing event or a down arrow button pressing event.

In this method, the display interface container is used as a unit to start listening. After the up arrow button pressing event or the down arrow button pressing event is received, a card container selection event corresponding to the up arrow button pressing event or the down arrow button pressing event is generated. A card container in which the target focus is located may be determined upon the detected card container selection event, and further, the target focus is determined in the target card container according to the preset focus up/clown movement algorithm. Because only one listener is started, system memory consumption is relatively small, which facilitates maintenance and reduces a risk of memory leakage. In addition, the focus movement algorithm can be uniformly managed and flexibly processed by using the uniform focus up/down movement algorithm, which facilitates maintenance and expansion.

With reference to the first aspect, in a possible design manner, after the electronic device is powered on and the display interface is displayed, if a button pressing event is received, a card located at a preset position in the display interface container is determined as the current focus. The button pressing event is generated based on an operation performed by a user on any button. For example, the card at the preset position may he the first card on the left of the first card container in the display interface container. For example, the card at the preset position may be a card at a middlemost position in the display interface container.

In this way, when the electronic device is powered on and the display interface is displayed, the user may press any button of a remote control to position a focus. Then, the focus can be moved by pressing an arrow button.

With reference to the first aspect, in a possible design manner, the determining a target focus in the target card container according to a focus up/down movement algorithm includes: determining, as the target focus, a card that is in the target card container and that has a largest area adjacent to the current focus.

With reference to the first aspect, in a possible design manner, if the target card container has a plurality of cards that have same areas adjacent to the current focus, one card in the plurality of cards is determined as the target focus according to a preset rule.

In a possible design manner, if the down arrow button pressing event is received, a leftmost card in the plurality of cards is determined as the target focus. If the up arrow button pressing event is received, a rightmost card in the plurality of cards is determined as the target focus.

With reference to the first aspect, in a possible design manner, the display interface includes a display region and a non-display region. If the target card container is in the non-display region or is partially displayed in the display region, each card container on the display interface is scrolled upward or downward, so that the target card container is completely displayed in the display region in this way, the target focus can be determined in the card container in the display region. In addition, when the target card container is displayed in the display region, the user can view a display effect of the target focus, and user experience is relatively good.

With reference to the first aspect, in a possible design manner, after the determining a target focus, a focus change interface may be further invoked to notify that the target focus is updated to the current focus. Compared with a method in which one listening is started for each card to obtain a focus change event, the focus change interface is invoked to notify that the target focus is updated to the current focus, which can reduce system memory consumption.

With reference to the first aspect, in a possible design manner, the plurality of card containers in the display interface container are arranged in one column, and the plurality of cards in each card container are arranged in one row

According to a second aspect, an embodiment of this application provides a focus management method applied to an electronic device. A display interface of the electronic device includes one display interface container, the display interface container includes one or more card containers, and each card container includes one or more cards. The focus management method may include: starting one card selection listening by using the display interface container as one unit, to monitor whether a card selection event is received; and after receiving the card selection event, determining a target focus according to a focus left/right movement algorithm. The card selection event is generated based on a current focus upon a left arrow button pressing event or a right arrow button pressing event.

In this method, the display interface container is used as a unit to start listening. After receiving the left arrow button pressing event or the right arrow button pressing event, a card selection event corresponding to the left arrow button pressing event or the right arrow button pressing event is generated. The target focus is determined upon the detected card selection event according to the preset focus left/right movement algorithm.

One listening is started by using the display interface container as one unit, which consumes relatively small system memory, facilitating maintenance and reducing a risk of memory leakage. In addition, the focus movement algorithm can be uniformly managed and flexibly processed by using the uniform focus left right movement algorithm, which facilitates maintenance and expansion.

With reference to the second aspect, in a possible design manner, the determining a target focus according to a focus left/right movement algorithm includes: if the left arrow button pressing event is received, determining, as the target focus, a card obtained by moving the current focus leftward by one position in a card container in which the current focus is located; or if the right arrow button pressing event is received, determining, as the target focus, a card obtained by moving the current focus rightward by one position in a card container in which the current focus is located.

With reference to the second aspect, in a possible design manner, after the electronic device is powered on and the display interface is displayed, if a button pressing event is received, a card located at a preset position in the display interface container is determined as a current focus. The button pressing event is generated based on an operation performed by a user on any button. For example, the card at the preset position may be the first card on the left of the first card container in the display interface container. For example, the card at the preset position may be a card at a middlemost position in the display interface container.

In this way, when the electronic device is powered on and the display interface is displayed, the user may press any button of a remote control to position a focus. Then, the focus can be moved by pressing an arrow button.

With reference to the second aspect, in a possible design manner, after the determining a target focus, a focus change interface may be further invoked to notify that the target focus is updated to the current focus. Compared with a method in which one listening is started for each card to obtain a focus change event, the focus change interface is invoked to notify that the target focus is updated to the current focus, which can reduce system memory consumption.

With reference to the second aspect, in a possible design manner, the plurality of card containers in the display interface container are arranged in one column, and the plurality of cards in each card container are arranged in one row

According to a third aspect, an embodiment of this application provides an electronic device. The electronic device may implement the focus management method applied to an electronic device according to the first aspect or the second aspect. The method may be implemented by software, hardware, or hardware executing corresponding software. In a possible design, the electronic device may include a display screen, a processor, and a memory. The processor is configured to support the electronic device to perform a corresponding function in the method in any one of the foregoing aspects. The memory is configured to be coupled to the processor, and store program instructions and data that are necessary for the electronic device.

According to a fourth aspect, an embodiment of this application provides a computer storage medium. The computer storage medium includes computer instructions. When the computer instructions are run on an electronic device, the electronic device is enabled to perform the focus management method applied to an electronic device according to any one of the foregoing aspects and the possible design manners of the foregoing aspects.

According to a fifth aspect, an embodiment of this application provides a computer program product. When the computer program product is run on a computer, the computer is enabled to perform the focus management method applied to an electronic device according to any one of the foregoing aspects and the possible design manners of the foregoing aspects.

For technical effects brought by the electronic device according to the third aspect, the computer storage medium according to the fourth aspect, and the computer program product according to the fifth aspect, refer to technical effects brought by the first aspect and different design manners of the first aspect. Details are not described herein again.

### BRIEF DESCRIPTION OF DRAWNGS

FIG. 1A is a schematic diagram 1 of an example of a display interface;

FIG. 1B is a schematic diagram 2 of an example of a display interface;

FIG. 2A is a schematic diagram 3 of an example of a display interface;

FIG. 2B is a schematic diagram 4 of an example of a display interface;

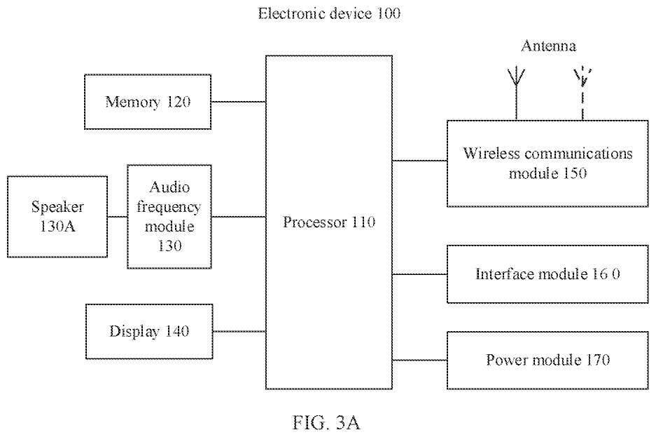

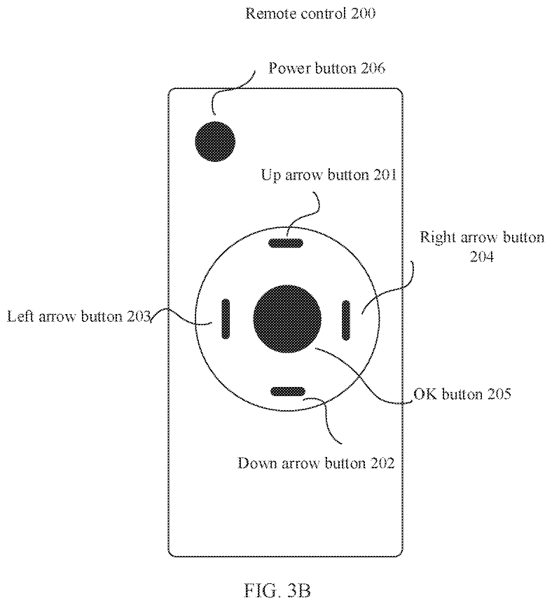

FIG. 3.A is a schematic diagram 1 of a structure of an electronic device according to an embodiment of this application;

FIG. 3B is a schematic diagram of a structure of a remote control according to an embodiment of this application;

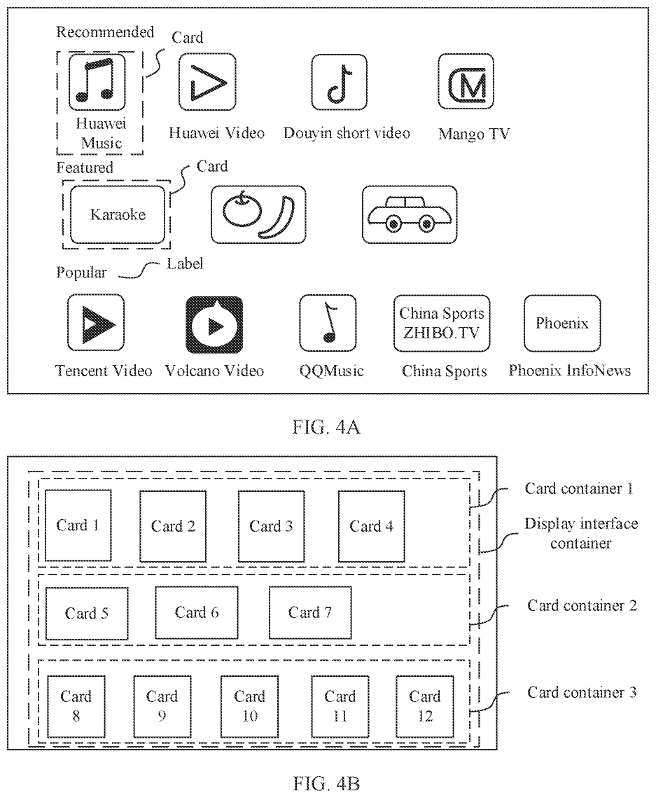

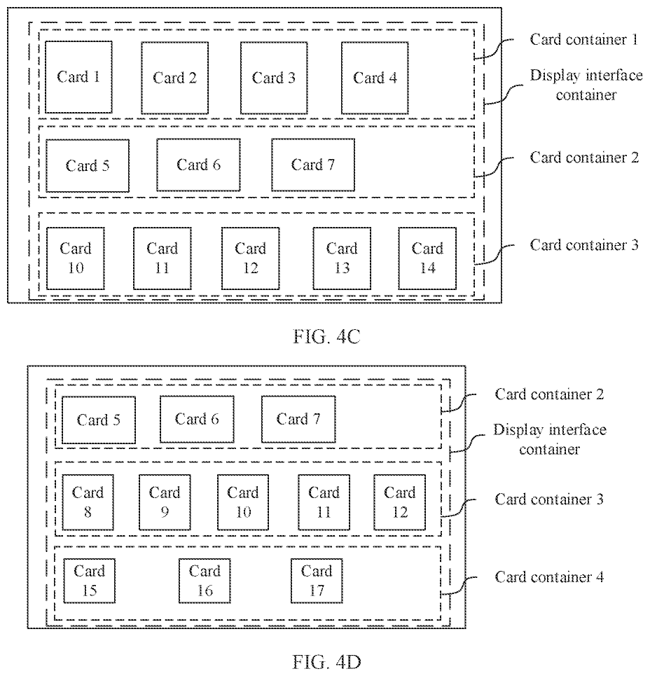

FIG. 4A is a schematic diagram 1 of a display interface to which a focus management method applied to an electronic device is applicable according to an embodiment of this application;

FIG. 4B is a schematic diagram 2 of a display interface to which a focus management method applied to an electronic device is applicable according to an embodiment of this application;

FIG. 4C is a schematic diagram 3 of a display interface to which a focus management method applied to an electronic device is applicable according to an embodiment of this application;

FIG. 4D is a schematic diagram 4 of a display interface to which a focus management method applied to an electronic device is applicable according to an embodiment of this application;

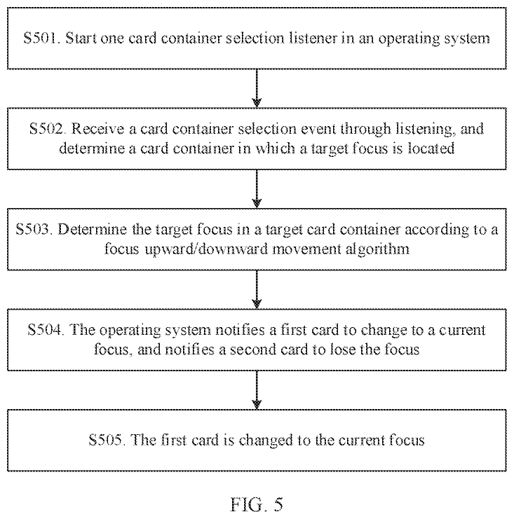

FIG. 5 is a schematic flowchart 1 of a focus management method applied to an electronic device according to an embodiment of this application;

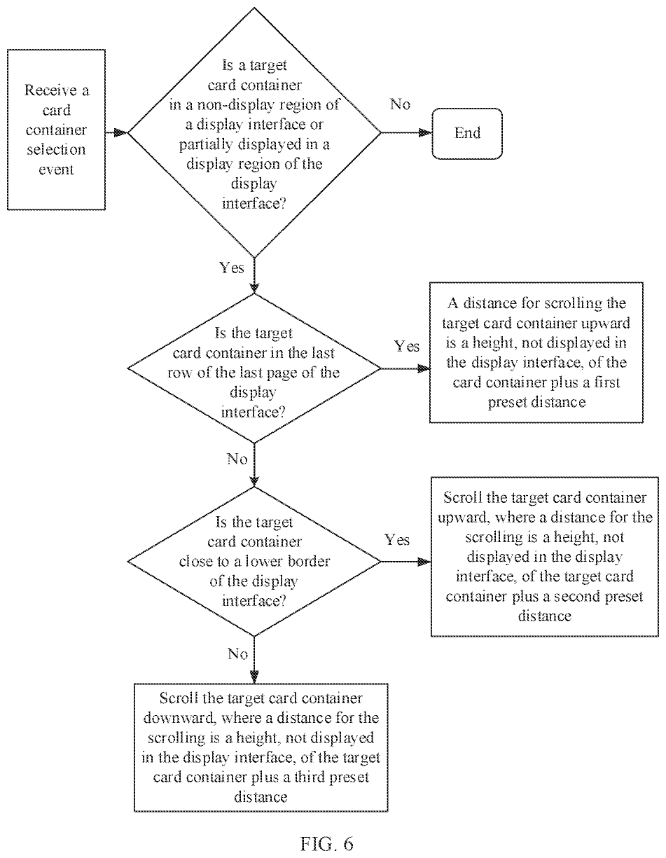

FIG. 6 is a schematic flowchart 2 of a focus management method applied to an electronic device according to an embodiment of this application;

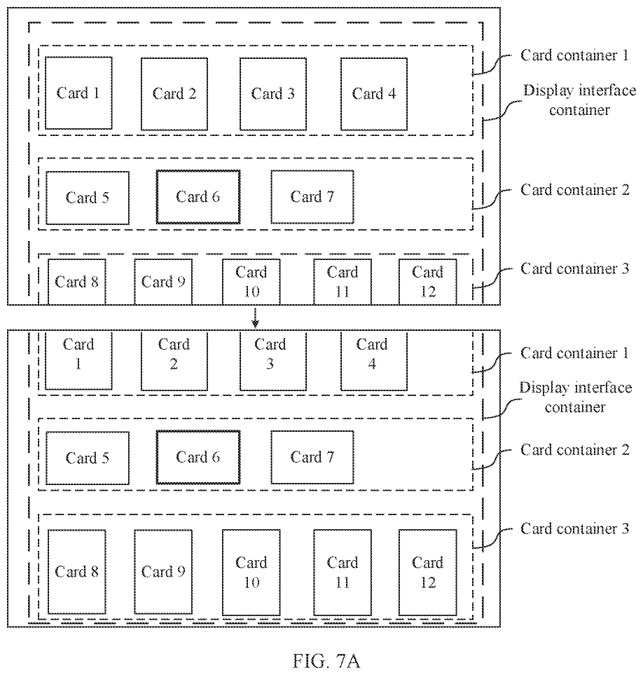

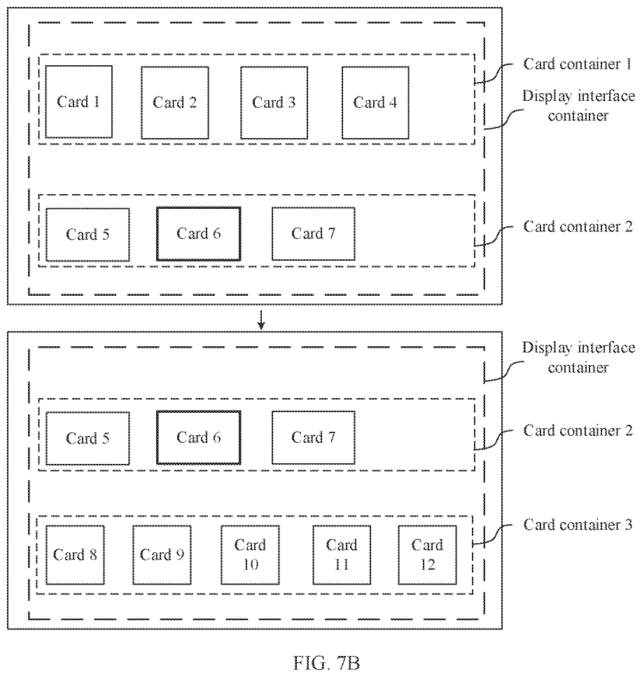

FIG. 7A is a diagram 1 of an example of a display interface of a focus management method applied to an electronic device according to an embodiment of this application;

FIG. 7B is a diagram 2 of an example of a display interface of a focus management method applied to an electronic device according to an embodiment of this application;

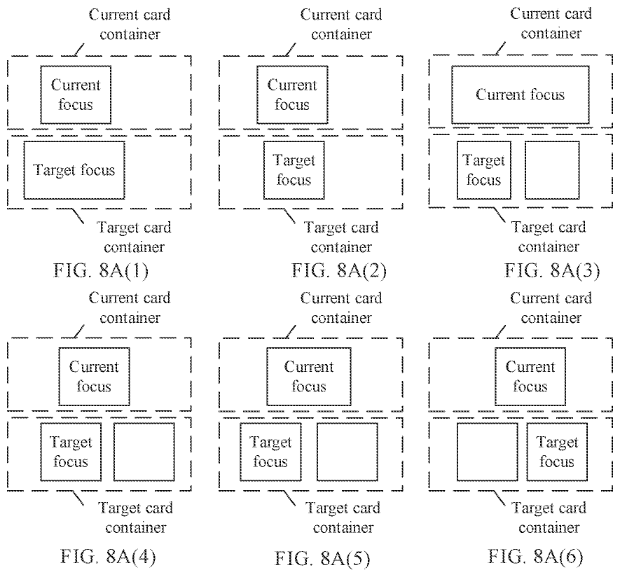

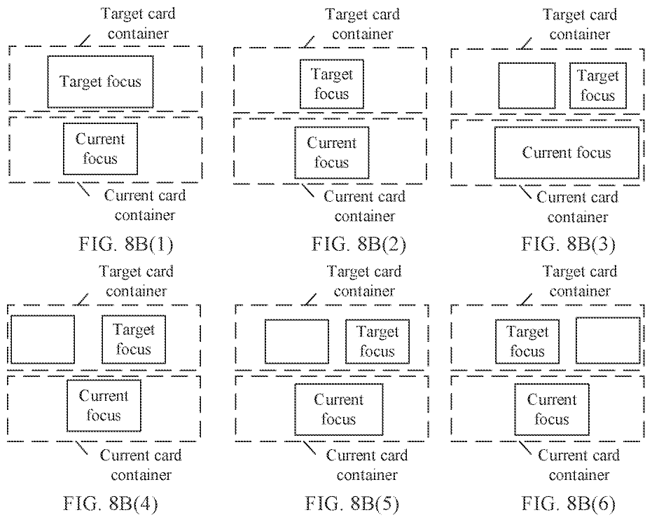

FIG. 8A(1) to FIG. 8A(6) are a schematic diagram 1 of a focus management method applied to an electronic device according to an embodiment of this application;

FIG. 8B(1) to FIG. 8B(6) are a schematic diagram 2 of a focus management method applied to an electronic device according to an embodiment of this application;

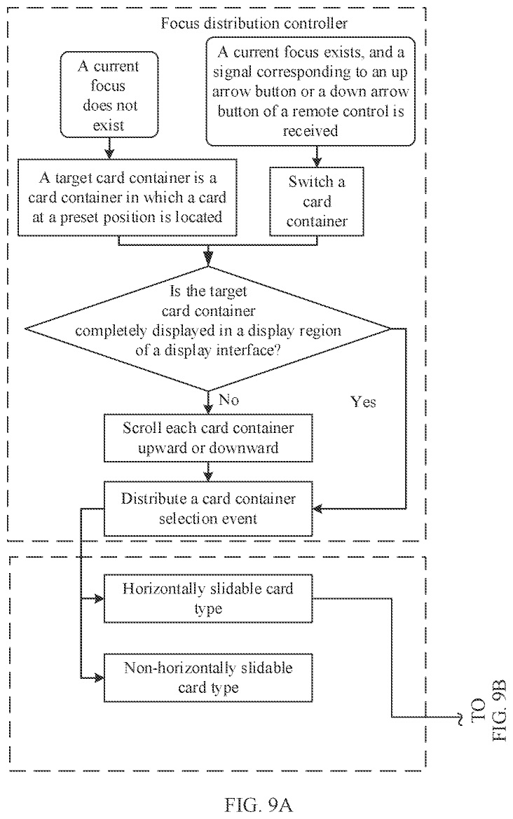

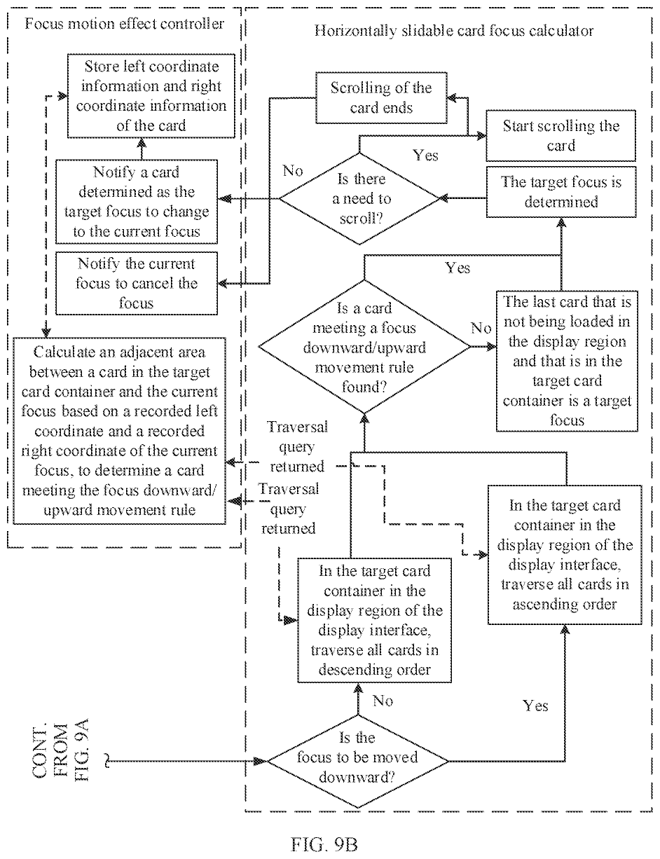

FIG. 9A and FIG. 9B are a schematic flowchart 3 of a focus management method applied to an electronic device according to an embodiment of this application;

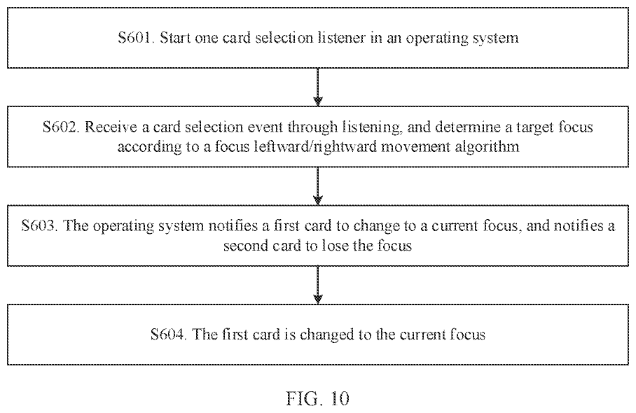

FIG. 10 is a schematic flowchart 4 of a focus management method applied to an electronic device according to an embodiment of this application;

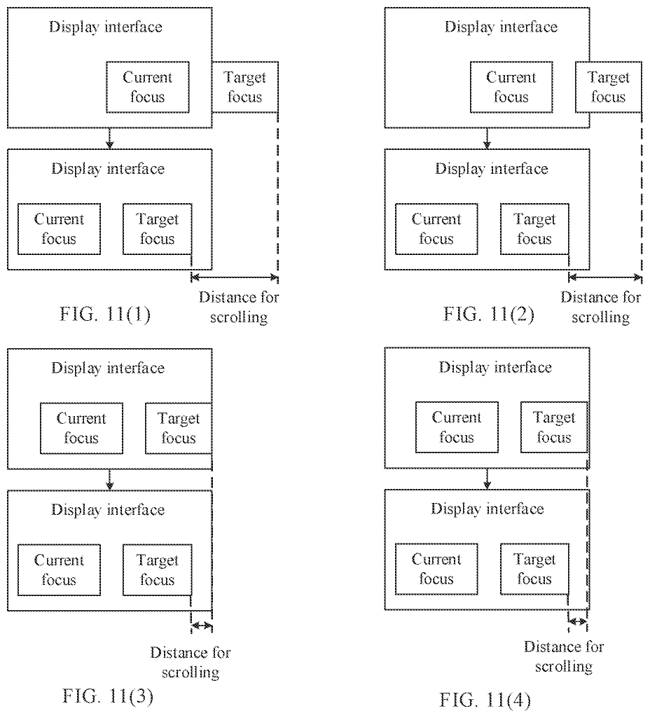

FIG. 11(1) to FIG. 11(4) are a schematic diagram 3 of a focus management method applied to an electronic device according to an embodiment of this application;

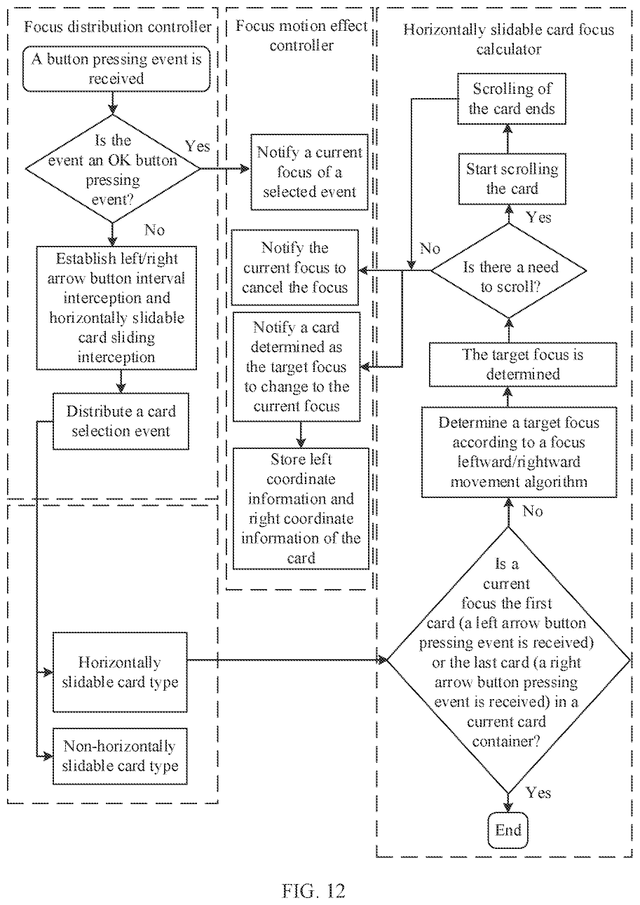

FIG. 12 is a schematic flowchart 5 of a focus management method applied to an electronic device according to an embodiment of this application; and

FIG. 13 is a schematic diagram 2 of a structure of an electronic device according to an embodiment of this application.

### DESCRIPTION OF EMBODIMENTS

A focus management method applied to an electronic device provided in embodiments of this application may be applied to an electronic device 100 shown in FIG. 3A.

The electronic device 100 may be a smart TV, a smart screen, a high-definition TV, a 4K TV, a smart projection, or the like. A specific form of the electronic device 100 is not specifically limited in this embodiment of this application.

FIG. 3A is a schematic diagram of a structure of an electronic device 100 according to an embodiment of this application. The electronic device 100 may include a processor 110, a memory 120, an audio frequency module 130, a speaker 130A, a display screen 140, a wireless communication module 150, an interface module 160, a power module 170, and the like.

It may be understood that the structure shown in this embodiment of the present invention does not constitute a specific limitation on the electronic device 100. In some other embodiments of this application, the electronic device 100 may include more or fewer components than those shown in the figure, or some components may be combined, or some components may be split, or there may be a different component layout. The components shown in the figure may be implemented by hardware, software, or a combination of software and hardware.

The foregoing components may also be distributed on different electronic devices. For example, the electronic device 100 may be in a form of a sett top box and a display.

The processor 110 may include one or more processors. For example, the processor 110 may include an application processor (application processor, AP), a controller, a video codec, a digital signal processor (digital signal processor, DSP), and/or the like. Different processors may be independent components, or may be integrated into one or more processors.

The controller may be a nerve center and a command center of the electronic device 100. The controller may generate an operation control signal based on an instruction operation code and a time sequence signal, to complete control of instruction fetching and instruction execution.

An operating system of the electronic device 100 may be installed on the application processor, and is configured to manage hardware and software resources of the electronic device 100, for example, managing and configuring memory, determining priority of system resource supply and demand, managing file systems, and managing drivers. The operating system may also be configured to provide an operating interface for a user to interact with the system. Various types of software, such as a driver and an application (application, App), may be installed in the operating system.

The digital signal processor is configured to process a digital signal, and may process another digital signal in addition to the digital image signal.

The video codec is configured to compress or decompress a digital video. The electronic device 100 may support one or more video codecs. In this way, the electronic device 100 may play videos of a plurality of encoding formats.

The memory 120 is configured to store instructions and data. In some embodiments, the memory 120 is a cache. The memory may store instructions or data used or cyclically used by the processor 110. If the processor 110 needs to use the instructions or the data again, the processor 110 may directly invoke the instructions or the data from the memory 120. This avoids repeated access and reduces a waiting time of the processor 110, thereby improving system efficiency.

In some embodiments, the memory 120 may alternatively be disposed in the processor 110. In other words, the processor 110 includes the memory 120. This is not limited in this embodiment of this application.

The audio frequency module 130 is configured to convert digital audio information into an analog audio signal output, and is also configured to convert an analog audio input into a digital audio signal. The audio frequency module 130 may be further configured to code and decode an audio signal. In some embodiments, the audio frequency module 130 may be disposed in the processor 110, or some function modules in the audio frequency module 130 are disposed in the processor 110.

The speaker 130A, also referred to as a “loudspeaker”, is configured to convert an audio electrical signal into a sound signal.

The electronic device 100 may implement audio functions such as sound play by using the audio frequency module 130, the speaker 130A, the application processor, and the like.

The display screen 140 is configured to display an image, a video, and the like. The display screen 140 includes a display panel. The display panel may be a liquid crystal display (liquid crystal display, LCD), an organic light-emitting diode (organic light-emitting diode, OLED), an active-matrix organic light-emitting diode or an active-matrix organic light-emitting diode (active-matrix organic light emitting diode, AMOLED), a flexible light-emitting diode (flex light-emitting diode, FLED), a mini-LED, a micro-LED, a micro-OLED, quantum dot light emitting diodes (quantum dot light emitting diodes, QLED), or the like. In this embodiment of this application, the display screen 140 may be configured to display a display interface of an App.

The wireless communication module 150 may provide a solution that is applied to the electronic device 100 and that includes wireless communication such as a wireless local area network (wireless local area networks, WLAN) (for example, a wireless fidelity (wireless fidelity, network), Bluetooth (bluetooth, BT), frequency modulation (frequency modulation, FM), and an infrared (IR) technology The wireless communications module 150 may be one or more components integrating at least one communications processing module. The wireless communications module 150 receives an electromagnetic wave through an antenna, performs frequency modulation and filtering processing on an electromagnetic wave signal, and sends a processed signal to the processor 110. For example, the wireless communication module 150 may be configured to implement communication between the electronic device 100 and a remote control in this embodiment of this application. The electronic device 100 may receive a signal of the remote control in a wireless communication manner such as Bluetooth or IR.

The interface module 160 may include a USB interface, an audio output interface, a high definition multimedia interface (high definition multimedia interface, HDMI), a memory card interface, and the like. The USB interface is an interface that conforms to a USB standard specification, and may be specifically a mini USB interface, a micro USB interface, a USB type-C interface, or the like. The USB interface may be configured to transmit data between the electronic device 100 and a peripheral device. For example, the electronic device 100 may be connected to an external storage device, an external camera, a game console, and the like through the USB interface. The audio output interface of the device is configured to connect to an external audio device, for example, to connect to a speaker. The HDMI is a fully digital video and audio transmission interface that can simultaneously send uncompressed audio and video signals. For example, the electronic device 100 may be connected to a device such as a wired set top box, a network set top box, a computer, or a speaker through the HDMI interface. The memory card interface is configured to connect to an external memory card, for example, a microSD card, to expand a storage capability of the electronic device 100.

The power module 170 may be configured to supply power to each component included in the electronic device 100.

Usually, the electronic device 100 is equipped with a remote control. The remote control is used to control the electronic device 100. FIG. 3B is a schematic diagram of a structure of a remote controller 200. The remote control 200 may include a plurality of buttons, for example, an up arrow button 201, a down arrow button 202, a left arrow button 203, a right arrow button 204, an OK button 205, and a power button 206. The button on the remote control 200 may be a mechanical button or a touch button. The remote controller 200 may receive a button input, generate a button signal input related to user settings and function control of the electronic device 100, and send corresponding signals to the electronic device 100 to control the electronic device 100. For example, when the user presses the up arrow button 201, the down arrow button 202, the left arrow button 203, the right arrow button 204, the OK button 205, or the power button 206, the button may send a corresponding signal, and sends the signal to the electronic device 100 in a manner such as Bluetooth or infrared. If the electronic device 100 receives, by using the wireless communication module 150 (for example, Bluetooth or IR), the signal corresponding to the button, the electronic device 100 may perform a corresponding operation based on the signal.

In an example, the up arrow button 201, the down arrow button 202, the left arrow button 203, and the right arrow button 204 are arrow buttons, and are configured to control a movement direction of an object in the electronic device 100. For example, in an App display interface, if receiving a signal corresponding to the up arrow button 201, the electronic device 100 moves a focus upward. If receiving a signal corresponding to the down arrow button 202, the electronic device 100 moves the focus downward. If receiving a signal corresponding to the left arrow button 203 is received, the electronic device 100 moves the focus leftward. If receiving a signal corresponding to the right arrow button 204, the electronic device 100 moves the focus rightward. The OK button 205 is configured to confirm an operation of the user. For example, the user may determine, by pressing the OK button 205, to select an object. When the focus is on one piece of displayed content, if receiving a signal corresponding to the OK button 205, the electronic device 100 determines to select this displayed content. The power button 206 is configured to control a power supply of the electronic device 100. For example, when receiving a signal corresponding to the power button 206, the electronic device 100 switches off the power supply.

It may be understood that the remote control 200 may further include other buttons and components, such as a volume button, a Bluetooth interface, an infrared interface, and a battery accommodation cavity (used for installation of a battery, to supply power to the remote control). Details are not described in this embodiment of this application.

It should be noted that, in some embodiments, buttons such as the up arrow button 201, the down arrow button 202, the left arrow button 203, the right arrow button 204, the OK button 205, and the power button 206 may alternatively be disposed on the electronic device 100. These buttons may be mechanical buttons or touch buttons. The electronic device 100 may receive a button input and generate a button signal input related to user settings and function control, to control the electronic device 100. A position of the button is not limited in this embodiment of this application.

In this embodiment of this application, a description is given with an example in which the electronic device 100 is a smart TV, the smart TV receives a button operation performed by the user on the remote control to control the smart TV.

An App display interface applied to the smart TV may include a plurality of pieces of displayed content. Among the plurality of displayed content, there is one piece of displayed content used as a focus. A display effect of the focus is different from that of other content. For example, the focus may highlight a border of corresponding displayed content, so as to distinguish it from other displayed content. The App may receive signals corresponding to arrow buttons on the remote control, and move a focus position based on a pressing operation performed by the user on an arrow button. It may be understood that, in this embodiment of this application, the App display interface may also be a main interface (namely, a desktop) of the electronic device 100.

In some embodiments, each piece of displayed content is used as one unit. For each piece of displayed content, a focus obtaining capability of the piece of displayed content may be set in a layout file of the App. For example, if the focus obtaining capability is set to true, it indicates that this piece of displayed content has the focus obtaining capability, that is, this piece of displayed content may become the focus. If the focus obtaining capability is set to false, it indicates that this piece of displayed content does not have the focus obtaining capability, that is, this piece of displayed content cannot become the focus.

In an implementation, the operating system of the electronic device uses each piece of displayed content as one unit to perform focus management. For example, the operating system of the smart TV is an Android system. When determining that a signal corresponding to an arrow button of the remote control is received, the Android system determines a target focus according to a preset focus determining rule, and triggers a focus loss event of the current focus and a focus obtaining event of the target focus.

One focus event listening is started for each piece of displayed content that has the focus obtaining capability, to monitor whether a focus change event (focus change events include the focus loss event and the focus obtaining event) is received. If a piece of displayed content receives the focus loss event, it is determined that this piece of displayed content is no longer the focus. If a piece of displayed content receives the focus obtaining event, it is determined that this piece of displayed content becomes the focus.

In another implementation, one button pressing event listening is started for each piece of displayed content that has the focus obtaining capability, to monitor whether a button pressing event is received. Button pressing events may include an up arrow button pressing event, a down arrow button pressing event, a left arrow button pressing event, and a right arrow button pressing event. When receiving a signal corresponding to the up arrow button of the remote control, the system triggers the up arrow button pressing event. When receiving a signal corresponding to the down arrow button of the remote control, the system triggers the down arrow button pressing event. When receiving a signal corresponding to the left arrow button of the remote control, the system triggers the left arrow button pressing event. When receiving a signal corresponding to the right arrow button of the remote control, the system triggers the right arrow button pressing event. After a piece of displayed content receives a button pressing event, the target focus is determined. according to the preset focus determining rule by using the current focus. In this implementation, the preset focus determining rule may he the same as a focus determining rule preset in the Android. system, or may be different from a focus determining rule preset in the Android system.

For example, the preset focus determining rule may include: an identifier of a target focus when a piece of displayed content is used as the current focus and when a signal corresponding to each arrow button is received. For example, for an App display interface shown in FIG. 1A, the preset focus determining rule is that when the current focus is the displayed content 1, if a signal corresponding to the right arrow button is received, the identifier of the target focus is an identifier of the displayed content 4; if a signal corresponding to the down arrow button is received, the identifier of the target focus is an identifier of the displayed content 2. When the current focus is the displayed content 2, if a signal corresponding to the right arrow button is received, the identifier of the target focus is an identifier of the displayed content 3. When the current focus is the displayed content 3, if a signal corresponding to the left arrow button is received, the identifier of the target focus is the identifier of the displayed content 2; if a signal corresponding to the right arrow button is received, the identifier of the target focus is an identifier of the displayed content 5; if a signal corresponding to the up arrow button is received, the identifier of the target focus is an identifier of the displayed content 1. When the current focus is the displayed content 4, if a signal corresponding to the left arrow button is received, the identifier of the target focus is the identifier of the displayed content 1; if a signal corresponding to the right arrow button, the identifier of the target focus is an identifier of the displayed content 6; if a signal corresponding to the down arrow button is received, the identifier of the target focus is the identifier of the displayed content 5. When the current focus is the displayed content 5, if a signal corresponding to the left arrow button is received, the identifier of the target focus is the identifier of the displayed content 3; if a signal corresponding to the right arrow button is received, the identifier of the target focus is the identifier of the displayed content 6; if a signal corresponding to the up arrow button is received, the identifier of the target focus is the identifier of the displayed content 4. When the current focus is the displayed content 6, if a signal corresponding to the left arrow button is received, the identifier of the target focus is the identifier of the displayed content 4.

For example, the preset focus determining rule may include: for a case in which positions of pieces of displayed content are vertically aligned, if a signal corresponding to the up arrow button is received, the focus is moved upward by one position; if a signal corresponding to the down arrow button is received, the focus is moved downward by one position. In a case in which positions of pieces of displayed content are horizontally aligned, if a signal corresponding to the left arrow button is received, the focus is moved leftward by one position; if a signal corresponding to the right arrow button is received, the focus is moved rightward by one position. For example, for an App display interface shown in FIG. 1B, when the current focus is displayed content in the second row and the second column, if a signal corresponding to the up arrow button is received, the target focus is displayed content in the first row and the second column; if a signal corresponding to the down arrow button is received, the target focus is displayed content in the third row and the second column; if a signal corresponding to the left arrow button, the target focus is displayed content in the second row and the first column; if a signal corresponding to the right arrow button is received, the target focus is displayed content in the second row and the third column.

For example, the preset focus determining rule may include the following: When there are a plurality of pieces of displayed content that correspond to and are below the current focus, if a signal corresponding to the down arrow button is received, the focus is moved to a leftmost piece of displayed content in the plurality of pieces of displayed content below the current focus. When there are a plurality of pieces of displayed content that correspond to and are above the current focus, if a signal corresponding to the up arrow button is received, the focus is moved to a leftmost piece of displayed content in the plurality of pieces of displayed content above the current focus. When there are a plurality of pieces of displayed content that correspond to and are on the left of the current focus, if a signal corresponding to the left arrow button is received, the focus is moved to an uppermost piece of displayed content in the plurality of pieces of displayed content on the left. When there are a plurality of pieces of displayed content that correspond to and are on the right side of the current focus, if a signal corresponding to the right arrow button is received, the focus is moved to an uppermost piece of displayed content in the plurality of pieces of displayed content on the right. For example, for the App display interface shown in FIG. 1A, when the current focus is the displayed content 1, if a signal corresponding to the don arrow button is received, the target focus is the displayed content 2. When the current focus is the displayed content 6, if a signal corresponding to the left arrow button is received, the target focus is the displayed content 4.

In any one of the foregoing implementations, one listening (focus event listening or button event listening) needs to be started correspondingly for each displayed content that has the focus obtaining capability, and each listening occupies particular system memory. When there are a relatively large quantity of pieces of content on the App display interface, a large amount of system memory is occupied for the listening, causing consumption of a large amount of system memory. In addition, because a relatively large quantity of listeners are started, it is inconvenient to manage and maintain these listeners. In some cases, if the focus determining rule needs to be changed, adaptive modification needs to be made for each piece of displayed content. When there are a large quantity of displayed content on the App display interface, adaptation workload is relatively large, and maintenance and expansion are not convenient.

This embodiment of this application provides a focus management method applied to an electronic device. All displayed content on an App display interface is used as one unit, and one listening is started. In this way, consumption of system memory can be reduced, and management and expansion are facilitated.

For ease of description, the following describes an App display interface to which a focus management method applied to an electronic device is applicable and provided in an embodiment of this application. Refer to FIG. 4A. The App display interface may include a plurality of pieces of displayed content (for example, Huawei Music, Huawei Video, and Karaoke), and may further include one or more labels (for example, recommended, featured, or popular).

Each piece of displayed content is referred to as a card. A specific form of the card is not limited in this embodiment of this application. For example, the card may be a form of a picture and a caption, or may be a form of a picture, or may be another form. In this embodiment of this application, each card has a focus obtaining capability.

Refer to FIG. 4B. The App display interface includes a plurality of cards. The plurality of cards belong to a display interface container, that is, the display interface container includes all cards on the App display interface. The display interface container includes one or more card containers, and each card container includes one or more cards. For example, the display interface container includes a card container 1, a card container 2, and a card container 3. The card container 1 includes a card 1, a card 2, a card 3, and a card 4. The card container 2 includes a card 5, a card 6, and a card 7. The card container 3 includes a card 8, a card 9, a card 10, a card 11, and a card 12. In some embodiments, the plurality of card containers are arranged in one column, and cards in each card container are arranged in one row

In some embodiments, the App display interface includes a display region and a non-display region.

In an example, a card container further includes a card that is not displayed. The card may be swiped left or right, that is, a display position of the card may be moved leftward or rightward, so that a card in the non-display region is moved to the display region for display. For example, the card container 3 further includes a card 13 and a card 14. The card 13 and the card 14 are not displayed in the display region of the App display interface shown in FIG. 4B. After a card in the card container 3 is swiped left, the App display interface shown in FIG. 4B may be changed to an App display interface shown in FIG. 4C. The card 8 and the card 9 in FIG. 4B are moved to the non-display region, and the card 13 and the card 14 are moved to the display region. In this embodiment of this application, a card that can be swiped left or right in the card container is referred to as a horizontally slidable card.

In an example, the display interface container further includes a card container that is not displayed. The card container may be scrolled upward or downward, so that a card container in the non-display region is scrolled to the display region. For example, the display interface container further includes a card container 4, and the card container 4 is not displayed in the display region of the App display interface shown in FIG. 4B. After a card container in the display interface container is scrolled upward, the App display interface shown in FIG. 4B may be changed to an

App display interface shown in FIG. 4D. The card container 1 in FIG. 4B is scrolled to the non-display region, and the card container 4 is scrolled to the display region.

It should be noted that the label has no focus obtaining capability, and the label is not shown in FIG. 4B, FIG. 4C, and FIG. 4D.

With reference to the accompanying drawings, the following describes in detail a focus management method applied to an electronic device provided in an embodiment of this application. The focus management method applied to an electronic device provided in this embodiment of this application may be applied to the electronic device 100 shown in FIG. 3A. A display interface of an App installed on the electronic device 100 includes characteristics shown in FIG. 4B, FIG. 4C, or FIG. 4D. The display interface of the App installed on the electronic device 100 includes one display interface container. The display interface container includes one or more card containers, and each card container includes one or more cards. The plurality of card containers are arranged in one column, and cards in each card container are arranged in one row.

As shown in FIG. 5, the focus management method applied to an electronic device provided in this embodiment of this application may include the following steps.

S501. Start one card container selection listening in an operating system.

A smart TV is used as an example of an electronic device. The operating system is installed on an application processor of the smart TV. For example, the operating system of the smart TV may be Android. An App is installed on the operating system. For example, a display interface of the App installed on the smart TV is shown in FIG. 4B.

The App display interface includes one display interface container. In the operating system, one card container selection listening is registered and started by using the display interface container as one unit, to monitor whether a card container selection event is received.

A user can control the Smart TV by pressing a button on a remote control. The operating system of the smart TV may receive a signal corresponding to a button of the remote control (for example, the remote control 200 in FIG. 3B). The operating system receives a signal corresponding to a button of the remote control, that is, receives a button pressing event. For example, a signal corresponding to an up arrow button is received, that is, an up arrow button pressing event is received. A signal corresponding to a down arrow button is received, that is, a down arrow button pressing event is received. A; a signal corresponding to a left arrow button, that is, a left arrow button pressing event is received. A; a signal corresponding to a right arrow button, that is, a right arrow button pressing event is received. A; a signal corresponding to an OK button is received, that is, an OK button event is received. A signal corresponding to the power button is received, that is, a power button event is received.

When the operating system receives a button pressing event, the operating system may trigger a corresponding operation.

In an example, the smart TV is powered on, and the App display interface of the smart TV is displayed. In this case, a current focus does not exist. The user can press any button (such as the up arrow button, the down arrow button, the left arrow button, the right arrow button, the OK arrow button, or a volume button) on the remote control, to determine a focus.

For example, the user presses any button on the remote control, to generate a corresponding control signal, and the corresponding control signal is sent to the smart TV. The operating system of the smart TV receives a signal corresponding to any button, that is, receives a button pressing event.

In an implementation, the operating system receives a button pressing event triggered. by any button, and may determine a card at a preset position in the display interface container as the focus. For example, the preset position may be a position (such as a position of a card 1 in FIG. 4B) of the first card on the left in the first card container on the App display interface. For example, the preset position may be a middle position (such as a position of a card 6 in FIG. 4B) on the App display interface. Preferably, the any button does not include the power button.

Optionally, in an implementation, the operating system may generate a card container selection event, and the card container selection event is used to indicate a card container in which a target focus is located. For example, if the preset position is a position of the first card on the left in the first card container, the card container in which the target focus is located is the first card container.

In an example, a current focus exists on the App display interface of the smart TV, that is, a card in the display interface container has obtained the focus. The user can control the focus to move by pressing the up arrow button, the down arrow button, the left arrow button, or the right arrow button on the remote control.

In some embodiments, if the operating system of the smart TV receives the up arrow button pressing event or the down arrow button pressing event, a card container selection event is generated based on the current focus. The card container selection event is used to indicate a card container in which a target focus is located. In this embodiment of this application, the card container in which the target focus is located is referred to as a target card container.

For example, if the down arrow button pressing event is received, it is determined that the target card container is a card container in a row above a card container in which the current focus is located. If the up arrow button pressing event is received, it is determined that the target card container is a card container in a row below a card container in which the current focus is located. For example, the current focus is the card 6 on the App display interface shown in FIG. 4B. If the operating system receives the up arrow button pressing event, it is determined that the target card container is the card container 1. If the operating system receives the down arrow button pressing event, it is determined that the target card container is the card container 3. The card container in which the current focus is located is referred to as a current card container.

The operating system may indicate the target card container by using the generated card. container selection event. In an implementation, the card container selection event carries card container indication information, and the card container indication information is used to indicate the target card container. For example, the card container indication information may be an identifier of the card container.

S502. Receive the card container selection event through listening, and determine a card container in which a target focus is located.

In an implementation, if the card container selection event is received through listening, the target card container is determined based on the card container indication information.

For example, in FIG. 4B, the display interface container receives the card container selection event, and determines, based on the card container indication information, that the target card container is the card container 3.

In some embodiments, if it is determined that the target card container is in a non-display region of the display interface or is partially displayed in a display region of the display interface, each card container may he scrolled upward or downward, so that the target card container is completely displayed in the display region.

Optionally, the display interface may include a plurality of pages, and each page includes one or more display interface containers. The plurality of display interface containers may be displayed page by page in the displayed interface. In an example, as shown in FIG. 6, the display interface container receives a card container selection event, and determines whether the target card container is in the non-display region of the display interface or is partially displayed in the display region of the display interface. If it is determined that the target card container is in the non-display region of the display interface or is partially displayed in the display region of the display interface, it is determined whether the target card container is in the last row of the last page of the display interface. If it is determined that the target card container is in the last row of the last page of the display interface, a distance for scrolling the target card container upward is a height, not displayed on the display interface, of the card container plus a first preset distance. If it is determined that the target card container is not in the last row of the last page of the display interface, it is determined whether the target card container is dose to a lower border of the display interface. If it is determined that the target card container is close to the lower border of the display interface, it is determined to scroll the target card container. A distance for the scrolling is a height, not displayed on the display interface, of the target card container plus a second preset distance. In an example, the second preset distance is greater than the first preset distance. If it is determined that the target card container is not close to the lower border of the display interface (to be specific, the target card container is close to an upper border of the display interface), it is determined to scroll the target card container downward. A distance for the scrolling is a height, not displayed on the display interface, of the target card container plus a third preset distance.

The scrolling upward is used as an example below.

For example, as shown in FIG. 7A, the current focus is the card 6, the display interface container receives a card container selection event, and it is determined that the target card container is the card container 3. If the card container 3 is partially displayed in the display region of the display interface, the card container 1, the card container 2, and the card container 3 are scrolled upward, so that the card container 3 is completely displayed in the display region.

For example, as shown in FIG. 7B, the current focus is the card 6, the display interface container receives a card container selection event, and it is determined that the target card container is the card container 3. If the card container 3 is in the non-display region of the display interface, the card container 1, the card container 2, and the card container 3 are scrolled upward, so that the card container 3 is completely displayed in the display region.

S503. Determine the target focus in the target card container according to a focus up/down movement algorithm.

The focus up/down movement algorithm may include a focus down movement algorithm and a focus up movement algorithm. If the current focus does not exist (for example, the smart TV is powered on, and the App display interface is displayed), the target focus is the card at the preset position. If the target card container is located below the current focus, the target focus is determined according to the focus down movement algorithm. If the target card container is located above the current focus, the target focus is determined according to the focus up movement algorithm.

In an implementation, left coordinate information and right coordinate information of the current focus may be recorded in the operating system. A left coordinate is an x-coordinate of a left border of a card, and the right coordinate is an x-coordinate of a right border of the card. For example, an focusXs array in the operating system is used to record the left coordinate information and the right coordinate information of the current focus.

In an example, the focus down movement algorithm includes:

iIn the target card container in the display region of the display interface, all cards are traversed in ascending order (from left to right), and a card meeting a focus down movement rule is determined as the target focus.

The focus down movement rule is that, among a plurality of cards in the target card container, a card having a largest area adjacent to the current focus is the target focus. If there are a plurality of cards that have same areas adjacent to the current focus, one card in the plurality of cards is determined as the target focus according to a preset rule. In an implementation, the target focus is a leftmost card in the plurality of cards. In this embodiment of this application, an adjacent area of two cards means an overlapping length of widths of the two cards on an abscissa axis. The width of the card means a length from an x-coordinate of a left border to an x-coordinate of a right border of the card.

If no card meeting the focus down movement rule exists in the target card container, for example, no cards in the target card container are adjacent to the current focus (an adjacent area is 0), it is determined that the target focus is a rightmost card in the target card container.

In an implementation, in the target card container in the display region, all cards are traversed in ascending order (from left to right), and an adjacent area between the card and the current focus is calculated according to a left coordinate and a right coordinate of the card.

Case 1: If a card is located exactly under the current focus, it is determined that the card is the target focus.

For example, if it is determined that a left coordinate of the card is less than a left coordinate of the current focus, and a right coordinate of the card is greater than a right coordinate of the current focus, it is determined that the card is the target focus, for example, as shown in FIG. 8A(1).

For example, if it is determined that a left coordinate of the card is greater than a left coordinate of the current focus, and a right coordinate of the card is less than a right coordinate of the current focus, it is determined that the card is the target focus, for example, as shown in FIG. 8A(2) and FIG. 8A(3).

Case 2: A card is in a lower left corner of the current focus. If an adjacent area between the card and the current focus plus a half of a spacing between two cards in the target card container is greater than or equal to a half of a width of the current focus, it is determined that the card is the target focus, for example, as shown in FIG. 8A(4) in and FIG. 8A(5).

Case 3: A card is in a lower right corner of the current focus. If an adjacent area between the card and the current focus plus a half of a spacing between two cards in the target card container is greater than a half of a width of the current focus, it is determined that the card is the target focus. for example, as shown in FIG. 8A(6).

The following is a specific example of an implementation of the focus down movement algorithm.

```
  / * *
  *@param rect represents coordinate information of a card to be determined
  *@param margin represents a spacing between cards
  *@ return represents that a card is a target focus if true is returned, or represents that a
card is not a target focus if false is returned
  *@ focusXs[0] represents a left coordinate of a current focus
  *@ focusXs[1] represents a right coordinate of a current focus
  */
  private boolean isDownInFocus(Rect rect, int margin) {
    if ((focusXs[0]==0 && focusXs[1]==0)^{∥}
        (focusXs[0]<=rect.left && focusXs[1] >= rect,right)^{∥}
        (focusXs[0]>=rect.left && focusXs[1] <= rect,right)){
        return true;
  } else if (isInFocusUnaligned(rect, margin)){
          return true;
  }
          return false;
  }
  private boolean isInFocusUnaligned (Rect rect, int margin) {
    if ((focusXs[0] >=rect.left && focusXs[l] >= rect.right)
        && (rect.right - focusXs[0] + margin /2 >= (focusXs[1] - focusXs[0])/2)) {
      //A card is located in a lower left corner of a current focus, and an adjacent area
between the card and the current focus plus a half of a spacing between two cards in a target card
container is greater than or equal to a half of a width of the current focus
        return true;
  } else if ((focusXs[0]<=rect.left && focusXs[1]<= rect.right))
        && (focusXs[1] -rect.left + margin /2 >=(focusXs[1] - focusXs[0])/2)) {
      //A card is located in a lower right corner of a current focus, and an adjacent area
between the card and the current focus plus a half of a spacing between two cards in a target card
container is great er than a half of a width of the current focus
        return true;
  }
        return false;
  }
```

In an example, the focus up movement algorithm includes:

iIn the target card container in the display region of the display interface, all cards are traversed in descending order (from right to left), and a card meeting a focus up movement rule is determined as the target focus.

The focus up movement rule is that, among a plurality of cards in the target card container, a card having a largest area adjacent to the current focus is the target focus. If there are a plurality of cards that have same areas adjacent to the current focus, one card in the plurality of cards is determined as the target focus according to a preset rule. In an implementation, the target focus is a rightmost card in the plurality of cards.

If no card meeting the focus up movement rule exists in the target card container, for example, no cards in the target card container are not adjacent to the current focus On adjacent area is 0), it is determined that the target focus is a rightmost card in the target card container.

In an implementation, in the target card container of the display region, all cards are traversed in descending order (from right to left), and an adjacent area between the card and the current focus is calculated based on a left coordinate and a right coordinate of the card.

Case 1: If a card is located exactly above the current focus, it is determined that the card is the target focus.

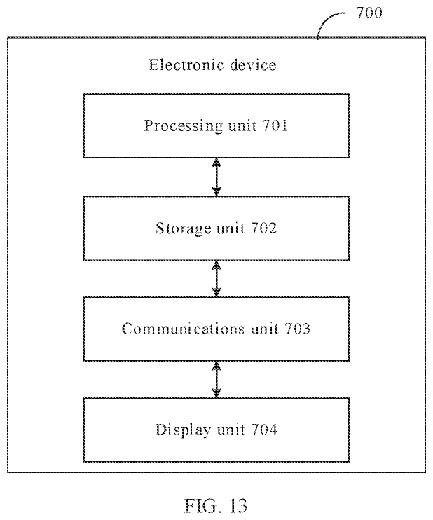

For example, if it is determined that a left coordinate of the card is less than a left coordinate of the current focus, and a right coordinate of the card is greater than a right coordinate of the current focus, it is determined that the card is the target focus, for example, as shown in FIG. 813(1).

For example, if it is determined that a left coordinate of the card is greater than a left coordinate of the current focus, and a right coordinate of the card is less than a right coordinate of the current focus, it is determined that the card is the target focus, for example, as shown in FIG. 813(2) and FIG. 8B(3).

Case 2: A card is in an upper right corner of the current focus. If an adjacent area between the card and the current focus plus a half of a spacing between two cards in the target card container is greater than or equal to a half of a width of the current focus, it is determined that the card is the target focus, for example, as shown in FIG. 8B(4) and FIG. 8B(5).

Case 3: A card is in an upper left corner of the current focus. If an adjacent area between the card and the current focus plus a half of a spacing between two cards in the target card container is greater than a half of a width of the current focus, it is determined that the card is the target focus, for example, as shown in FIG. 8B(6).

S504. The operating system notifies a first card to change to the current focus, and. notifies a second card to lose the focus.

The first card is the target focus determined in the foregoing step, and the second card is the current focus in the foregoing step.

In an implementation, each card has a view object, and an identifier of the view object may be created during initialization. After determining the target focus, the operating system invokes a focus change interface to notify the first card to change to the current focus, and invoke the focus change interface to notify the second card to be no longer the current focus.

S505. The first card changes to the current focus.

For example, left coordinate information and right coordinate information of the first card may be updated to the focusXs array.

In an implementation, processing of the first card in a card base class is changed to an operation of the current focus. For example, a focus effect of the card base class may be defined in a layout file. The focus effect can be a border flying style, a breathing border, a light sweep border, or the like. The first card implements, based on a focus motion effect of the card base class defined in the layout file, a motion effect of changing the first card to the current focus. In this way, the focus motion effect can be uniformly managed, facilitating maintenance and expansion.

According to the focus management method applied to an electronic device provided in this embodiment of this application, the listening is started by using the display interface container as one unit, the target card container is determined based on the received card container selection event, and the target focus is determined in the target card container according to the focus up/down movement algorithm. Because only one listening is started, system memory consumption is relatively small, which facilitates maintenance and reduces a risk of memory leakage. In addition, the focus movement algorithm can be uniformly managed and can be flexibly processed, which facilitates maintenance and expansion.

It may be understood that, when implementing the foregoing functions, the foregoing operating system may be divided into different modules. In an example, the operating system may include a focus distribution controller, a focus calculator, and a focus motion effect controller. With reference to functions of the modules, the following describes the focus management method applied to an electronic device shown in FIG. 5.

Refer to FIG. 9A and FIG. 9B. In the focus distribution controller, one card container selection listening is registered and started by using a display interface container as one unit, to monitor whether a card container selection event is received. The display interface container receives the card container selection event, and if it is determined that a current focus does not exist, it is determined that a target card container is a card container in which a card at a preset position is located. If a current focus exists, and a signal corresponding to an up arrow button or a down arrow button of a remote control is received, it is determined to switch the card container, and a target card container may be determined based on card container indication information. In some embodiments, the focus distribution controller determines whether the target card container is completely displayed in a display region of a display interface. If it is determined that the target card container is not completely displayed in the display region of the display interface, each card container is scrolled upward or downward, so that the target card container is completely displayed in the display region.

Further, the focus distribution controller distributes the card container selection event. In an implementation, the focus distribution controller determines a container type of the target card container. For example, the container type of the target card container may be determined based on an identifier of the target card container. The container type may include a horizontally slidable card type and a non-horizontally slidable card type. If a card included in a card container is a horizontally slidable card, a container type of the card container is the horizontally slidable card type. If a card included in a card container is a non-sliding card, a container type of the card container is the non-horizontally slidable card type. The focus distribution controller distributes card container selection events to different types of focus calculators based on the container type of the target card container. For example, the focus calculator may include a horizontally slidable card focus calculator and a non-horizontally slidable card focus calculator. If it is determined that the container type of the target card container is the horizontally slidable card type, the card container selection event is distributed to the horizontally slidable card focus calculator. If it is determined that that container type of the target card container is the non-horizontally slidable card type, the card container selection event is distributed to the non-horizontally slidable card focus calculator.

For example, the container type of the target card container is the horizontally slidable card type. If the horizontally slidable card focus calculator receives a card container selection event, the target focus is determined in the target card container according to a focus up/down movement algorithm. The horizontally slidable card focus calculator determines whether to move the focus downward. For example, if the target card container is located below the current focus, the horizontally slidable card focus calculator determines to move the focus downward; or if the target card container is above the current focus, determines to move the focus upward.

If it is determined to move the focus downward, in the target card container in the display region of the display interface, all cards are traversed in ascending order. If it is determined to move the focus upward, in reverse order in the target card container in the display region of the display interface, all cards are traversed in descending order.

The horizontally slidable card focus calculator notifies the focus motion effect controller to perform traversal query in the target card container. The focus motion effect controller calculates an adjacent area between a card in the target card container and the current focus based on a recorded left coordinate and a recorded right coordinate of the current focus, to determine a card meeting a focus down/up movement rule. The focus motion effect controller further returns a result of the traversal query to the horizontally slidable card focus calculator. The result of the traversal query may include: a card meeting the focus down/up movement rule is found, and a card meeting the focus down/up movement rule is not found. Optionally, if it is determined that the current focus does not exist, that a card meeting the focus down/up movement rule is found is returned.

The horizontally slidable card focus calculator determines a target focus based on the result returned by the focus motion effect controller if a card meeting the focus down/up movement rule is found in the target card container. The horizontally slidable card focus calculator determines that the last card that is not being loaded in the display region and that is in the target card container is a target focus if a card meeting the focus down/up movement rule is not found in the target card container. After the target focus is determined, it is determined whether the card needs to be scrolled. For example, if the card is not completely displayed, the card needs to be scrolled to be completely displayed in the display region. If the card is close to a border of the display interface, the card needs to be scrolled, and a distance for the scrolling is a distance between two cards in the target card container. If a distance between the card and a border of the display interface is less than a distance between two cards in the target card container, the card needs to be scrolled so that the distance between the card and the border of the display interface is equal to the distance between two cards in the target card container. If it is determined that that card needs to be scrolled, the card starts to be scrolled. If the card does not need to be scrolled, or scrolling of the card ends, the horizontally slidable card focus calculator notifies the focus motion effect controller of the focus change. The horizontally slidable card focus calculator notifies the current focus to cancel the focus, and notifies a card determined as the target focus to change to the current focus.

After the card determined as the target focus receives the notification of changing the card to the current focus, the focus motion effect controller may store left coordinate information and right coordinate information of the card.

It should be noted that division manners of the modules and functions implemented by the modules are merely examples for description. In actual application, there may be different division manners. This is not limited in this embodiment of this application.

In some embodiments, a user may alternatively move the focus leftward by pressing a left arrow button of the remote control, or move the focus rightward by pressing a right arrow button of the remote control, and determine to select a card by pressing an OK button of the remote control. As shown in FIG. 10, the focus management method applied to an electronic device provided in this embodiment of this application may further include the following steps.

S601. Start one card selection listening in an operating system.

In the operating system one card selection listening is registered and started by using a display interface container as one unit, to monitor whether a card selection event is received.

In some embodiments, an operating system of a smart TV receives a left arrow button pressing event or a right arrow button pressing event, and generates a card selection event based on a current focus. Optionally, the operating system of the smart TV receives an OK button event, and may also generate a card selection event.

S602. Receive the card selection event through listening, and determine a target focus according to a focus left/right movement algorithm.

The card selection event is received through listening, and if it is determined that a button pressing event is the left arrow button pressing event or the right arrow button pressing event, the target focus is determined according to the focus left/right movement algorithm. If it is determined that a button pressing event is the OK button event, it is determined that the current focus is selected.

The focus left/right movement algorithm may include the following: If it is determined that the left arrow button pressing event is received, it is determined that the target focus is a card obtained by moving the current focus leftward by one position in a current card container. If the current focus is the first card on the left in the current card container, it is determined that the target focus does not exist, that is, the focus is not moved. If it is determined that the right arrow button pressing event is received, it is determined that the target focus is a card obtained by moving the current focus rightward by one position in the current card container. If the current focus is the last card from left to right in the current card container, it is determined that the target focus does not exist, that is, the focus is not moved. The current card container is a card container in which the current focus is located.

In an implementation, if it is determined that the target focus exist, it is determined whether the card needs to be scrolled left or right. For example, the right arrow button pressing event is received. If the target focus is not displayed in a display region, the card is scrolled leftward, and a distance for the scrolling is a width of the card plus a spacing between two cards in the current card container, for example, as shown in FIG. 11(1). If the target focus is partially displayed in the display region, the card is scrolled leftward, and a distance for the scrolling is a width of a non-displayed part of the card plus a distance between two cards in the current card container, for example, as shown in FIG. 11(2). If the target focus is completely displayed in the display region, and the card is close to a right border of a display interface, the card is scrolled leftward, and a distance for the scrolling is equal to a distance between two cards in the current card container, for example, as shown in FIG. 11(3). If the target focus is completely displayed in the display region, and a distance between the card and a right border of the display interface is less than a distance between two cards in the current card container, the card is scrolled leftward, and a distance for the scrolling is the distance between two cards in the current card container minus the distance between the card and the right border of the display interface, for example, as shown in FIG. 11(4).

It may be understood that, the left arrow button pressing event is received, and if the target focus is not displayed in the display region, the card is scrolled rightward, and a distance for the scrolling is a width of the card plus a spacing between two cards in the current card container. If the target focus is partially displayed in the display region, the card is scrolled rightward, and a distance for the scrolling is a width of a non-displayed part of the card plus a distance between two cards in the current card container. If the target focus is completely displayed in the display region, and the card is close to a left border of the display interface, the card is scrolled rightward, and a distance for the distance is a distance between two cards in the current card container. If the target focus is completely displayed in the display region, and a distance between the card and a left border of the display interface is less than a distance between two cards in the current card container, the card is scrolled rightward, and a distance for the scrolling is a distance between two cards in the current card container minus the distance between the card and the left border of the display interface.

The following is a specific example of an implementation of the foregoing method for scrolling a card to leftward or rightward.

```
  boolean showAll = view.getGlobalVisibleRect(rect);
  int visibleOffset = rect.width();
  //Obtain a width of a card
  Int drawOffset = getViewWidth();
  //Not displayed in a display region. Scroll by a width of the card plus a card spacing
  if (! showAll) {
    HiApplog.dLimit (TAG, s: “dealFoucsView, not displayed”);
    doHorizonSmoothScroll(isRight, rightSpace:drawOffset+horizonMargin,
      leftSpace: -drawOffset - horizonMargin);
  }
  //Partially displayed in the display region. Scroll a missing part of the card plus the card
spacing
  else if(visibleOffset< drawOffset) {
    HiApplog.dLimit (TAG, s: “dealFoucsView, not fully displayed”);
    doHorizonSmoothScroll(isRight,
      rightspace: drawOffset - visibleOffset + horizonMargin,
      leftSpace: -drawOffset +visibleOffset - horizonMargin);
  }
  //Close to a right border of a display interface. Scroll by a card spacing
  else if(rect.left==0 rect.right==screenWidth) {
    HiApplog.dLimit (TAG, s: “dealFoucsView, close to the screen marin”);
    doHorizonSmoothScroll(isRight, horizonMargin, - horizonMargin);
  }
  //Close to the right border of the display interface with a spacing less than the card
spacing. Scroll by a difference between the spacings
  else if(TVFoucsComputeUtil,isRightSpaceLow(rect, screenWidth, horizonMargin)
      ^{∥}TVFoucsComputeUtil,isLeftSpaceLow(rect, horizonMargin))
  HiApplog.dLimit(TAG,
    s: “dealFoucsView; near to the margin, but the separation distance is less than the
card spacing”);
    doHorizonSmoothScroll(isRight, rightSpace: horizonMargin - (screenWidth -
rect.right), leftSpace: rect.left - horizonMargin);
  } else {
    setEffectController();
    setViewFoucs(childCount);
  }
```

S603. The operating system notifies a first card to change to the current focus, and notifies the second card to lose the focus.

For detailed description, refer to S504. Details are not described herein again.

S604. The first card changes to the current focus.

For detailed description, refer to S505. Details are not described herein again.

According to the focus management method applied to an electronic device provided in this embodiment of this application, the listening is started by using the display interface container as one unit, and after a card selection event is received, the target focus is determined based on the focus left/right movement algorithm. This can reduce system memory consumption, reduce a risk of memory leakage, and facilitate maintenance and management.

It may be understood that, when implementing the foregoing functions, the foregoing operating system may he divided into different modules. In an example, the operating system may include a focus distribution controller, a focus calculator, and a focus motion effect controller. With reference to functions of the modules, the following describes the focus management method applied to an electronic device shown in FIG. 10.

Refer to FIG. 12. In the focus distribution controller, the operating system receives a button pressing event, and determines whether the button pressing event is an OK button event. If it is determined that the received button event is the OK button event, the focus motion effect controller is notified to select a current focus, for example, the current focus is notified of a selection event. If it is determined that the received button event is not the OK button event (to be specific, the button pressing event is a left arrow button pressing event or a right arrow button pressing event), a card selection event is generated. Further, the focus distribution controller distributes the card selection event. Optionally, before the card selection event is distributed, left/right arrow button interval interception and the horizontally slidable card sliding interception may be further established. The left/right arrow button interval interception means that after one left arrow button pressing event or right arrow button pressing event is received, a received left arrow button pressing event or right arrow button pressing event is ignored within a preset first time interval (for example, 200 ms). The horizontally slidable card sliding interception means that after one horizontally slidable card sliding operation is received, a received horizontally slidable card sliding operation is ignored within a preset second time interval (for example, 100 ms).

In an implementation, the focus distribution controller determines a container type of a current card container. The focus distribution controller distributes card selection events to different types of focus calculators based on the container type of the current card container. If it is determined that the container type of the current card container is a horizontally slidable card type, the card selection event is distributed to a horizontally slidable card focus calculator. If it is determined that that the container type of the current card container is a non-horizontally slidable card type, the card selection event is distributed to a non-horizontally slidable card focus calculator.

For example, the container type of the current card container is the horizontally slidable card type. After receiving a card selection event, the horizontally slidable card focus calculator determines whether the current focus is the first card (the left arrow button pressing event is received) or the last card (the right arrow button pressing event is received) in the current card container. If yes, it is determined that a target focus does not exist, and the procedure ends. If no, a target focus is determined according to a focus left/right movement algorithm.

After the target focus is determined, it is determined whether the card needs to be scrolled. For example, if the card is not displayed, the card needs to be displayed in a display region through scrolling. If the card is not completely displayed, the card needs to be completely displayed in a display region through scrolling. If the card is close to a border of a display interface, the card needs to be scrolled, and a distance for the scrolling is a distance between two cards in the current card container. If a distance between the card and a border of a display interface is less than a distance between two cards in the current card container, the card needs to be scrolled so that the distance between the card and the border of the display interface is equal to the distance between two cards in the target card container. If it is determined that that card needs to be scrolled, the card starts to be scrolled. If the card does not need to he scrolled, or scrolling of the card ends, the horizontally slidable card focus calculator notifies the focus motion effect controller of the focus change. The horizontally slidable card focus calculator notifies the current focus to cancel the focus, and notifies a card determined as the target focus to change to the current focus.

After the card determined as the target focus receives the notification of changing the card to the current focus, the focus motion effect controller may store left coordinate information and right coordinate information of the card.

A person skilled in the art may understand that, although the focus management method corresponding to FIG. 5 and the focus management method corresponding to FIG. 10 are separately described in the embodiments of this application, the electronic device (smart TV) may simultaneously apply the two focus management methods. Actually, when controlling the electronic device to determine the target focus by using, for example, a remote control, a user may both press the left arrow button or the right arrow button and the up arrow button or the down arrow button, so that the electronic device starts the card container selection listening and the card selection listening.

It should be noted that the foregoing division manners of the modules and functions implemented by the modules are merely examples for description. In actual application, there may be different division manners. This is not limited in this embodiment of this application.

It may be understood that, to implement the foregoing functions, the electronic device includes a corresponding hardware structure and/or software module tier performing each of the functions. A person skilled in the art should be easily aware that, in combination with the examples described in the embodiments disclosed in this specification, units, algorithms, and steps may be implemented by hardware or a combination of hardware and computer software in the embodiments of this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the embodiments of this application.

In the embodiments of this application, the electronic device may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that division into the modules is an example and is merely logical function division in the embodiments of this application. In an actual implementation, another division manner may be used.

When an integrated unit is used, FIG. 13 is a schematic diagram of a possible structure of the electronic device in the foregoing embodiments. The electronic device 700 includes a processing unit 701, a storage unit 702, a communication unit 703, and a display unit 704.

The processing unit 701 is configured to control and manage an action of the electronic device 700, for example, may be configured to perform processing steps such as determining a target focus, changing to a focus, losing the focus, and providing a focus motion effect in the embodiments of this application, acid/or other processes for the technologies described in this specification.

The storage unit 702 is configured to store program code and data of the electronic device 700, for example, may be configured to store a layout file and the like.

The communication unit 703 is configured to support communication between the electronic device 700 and another apparatus, for example, may be configured to receive a signal corresponding to a button of a remote control.

The display unit 704 is configured to display an interface of the electronic device 700, for example, may be configured to display an App display interface, and/or other processes for the technologies described in this specification.

Certainly, units or modules in the electronic device 700 include but are not limited to the processing unit 701, the storage unit 702, the communication unit 703, and the display unit 704. For example, the electronic device 700 may further include an audio frequency unit and the like. The audio frequency unit is configured to play sound, music, and the like. In some embodiments, the audio frequency unit may be further configured to collect a voice sent by the user.

The processing unit 701 may be a processor or a controller, for example, may be a central processing unit (central processing unit, CPU), a digital signal processor (digital signal processor, DSP), an application-specific integrated circuit (application-specific integrated circuit, ASIC), a field programmable gate array (field programmable gate array, FPGA) or another programmable logic component, a transistor logic component, a hardware component, or any combination thereof. The processor may include an application processor and the like. The processor may implement or execute various example logical blocks, modules, and circuits described with reference to content disclosed in this application. Alternatively, the processor may be a combination of processors implementing a computing function, for example, a combination of one or more microprocessors, or a combination of the DSP and a microprocessor. The storage unit 702 may be a memory. The communications unit 703 may be a transceiver, a transceiver circuit, a communications interface, or the like. The display unit 704 may be a display screen. The audio frequency unit may include a microphone, a speaker, a receiver, and the like.

For example, the processing unit 701 is a processor (such as the processor 110 shown in FIG. 3A), the storage unit 702 may be a memory (such as the memory 120 shown in FIG. 3A), the communication unit 703 may be a wireless communication module (such as the wireless communication module 150 shown in FIG. 3A), a communications interface, or the like, and the display unit 704 is a display screen (such as the display screen 140 shown in FIG, 3A). The audio frequency unit may include a speaker (such as the speaker 130A as shown in FIG. 3A) and an audio frequency module (such as the audio frequency module 130 as shown in FIG. 3A). The electronic device 700 provided in this embodiment of this application may be the electronic device 100 shown in FIG. 3A. The processor, the memory, the display screen, the communications interface, and the like may be coupled together, for example, connected by using a bus.

An embodiment of this application further provides a computer storage medium. The computer storage medium stores computer program code, and when the processor executes the computer program code, the electronic device performs related method steps in FIG. 5 or FIG. 10 to implement the method in the foregoing embodiments.

An embodiment of this application further provides a computer program product. When the computer program product is run on a computer, the computer is enabled to perform related method steps in FIG. 5 or FIG. 10 to implement the method in the foregoing embodiments.

The electronic device 700, the computer storage medium, and the computer program product provided in the embodiments of this application each are configured to perform the corresponding method provided above. Therefore, for beneficial effects that can be achieved by the electronic device 700, the computer storage medium, and the computer program product, refer to the beneficial effects in the corresponding methods provided above. Details are not described herein again.

The foregoing descriptions about the implementations allow a person skilled in the art to clearly understand that, for convenient and brief description, division into the foregoing function modules is merely used as an example for description. In actual application, the foregoing functions can be allocated to different function modules for implementation according to a requirement. In other words, an inner structure of an apparatus is divided into different function modules to implement all or some of the functions described above.

In the several embodiments provided in this application, it should be understood that the disclosed apparatuses and methods may be implemented in other manners. For example, the described apparatus embodiments are merely examples. For example, division into the modules or units is merely logical function division, and may be other division in an actual implementation. For example, a plurality of units or components may be combined or may be integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate components may or may not be physically separate, and components displayed as units may he one or more physical units, that is, may be located in one place, or may be distributed in a plurality of different places. Some or all of the units may be selected based on actual requirements to achieve the objectives of the solutions in the embodiments.

In addition, function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a readable storage medium. Based on such an understanding, the technical solutions of the embodiments of this application essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor (processor) to perform all or some of the steps of the methods in the embodiments of this application. The foregoing storage medium includes any medium that can store program code, for example, a USB flash drive, a removable hard disk, a ROM, a RAM, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A method applied to an electronic device comprising wherein a display interface wherein the method comprises:
attempting to detect, using a display interface container of the display interface, a card container selection, wherein the display interface container comprises one or more card containers having one or more cards:
detecting, using the card container selection and based on a current focus, a card container selection event generated upon either an up arrow button pressing event or a down arrow button pressing event;
determining, according to the card container selection event, a target card container in which a target focus is located, and
selecting, as the target focus and according to a focus up movement algorithm or a focus down movement algorithm, a card in the target card container that has a largest area adjacent to the current.

2. (canceled)

3. The method of claim 1, further comprising determining the card in a plurality of cards according to a preset rule when the target card container has the plurality of cards that have same areas adjacent to the current focus.

4. The method of claim 3, further comprising determining a leftmost card in the plurality of cards as the target focus when the card container selection event is generated upon the down arrow button pressing event.

5. The method of claim 3, further comprising determining a rightmost card in the plurality of cards as the target focus when the card container selection event is generated upon the up arrow button pressing event.

6. The method of claim 1, wherein the display interface further comprises a display region and a non-display region, and wherein the method further comprises scrolling each card container on the display interface upward or downward; such that the target card container is completely displayed in the display region when the target card container is in the non-display region or is partially displayed in the display region.

7. A method applied to an electronic device comprising a display interface, wherein the method comprises:
attempting to detect, using a display interface container of the display interface, a card selection, wherein the display interface container comprises one or more card containers having one or more cards,
detecting, using the card selection and based on a current focus, a card selection event generated upon either a left arrow button pressing event or a right arrow button pressing event;
determining, in response to receiving the card selection event and according to a focus left movement algorithm or a focus right movement algorithm, a target focus,
receiving, based on an operation performed by a user on a button, a button pressing even when the electronic device is powered on and the display interface is displayed; and
determining, in response to the button pressing event, a card at a preset position in the display interface container as the current focus.

8. The method of claim 7, wherein determining the target focus comprises:
determining, as the target focus, a first card obtained by moving the current focus leftward by a first position in a first card container in which the current focus is located when the card selection event is generated based upon the left arrow button pressing event; and
determining, as the target focus, a second card obtained by moving the current focus rightward by a second position in a second card container in which the current focus is located when the card selection event is generated upon the right arrow button pressing event.

9. (canceled)

10. The method of claim 1 further comprising invoking a focus change interface to notify that the target focus is updated to the current focus.

11. The method according to claims 1, wherein the one or more card containers are arranged in a column, and wherein the one or more cards in each card container are arranged in a row.

12. An electronic device comprising
a display interface comprising a display interface container, wherein the display interface container comprises one or more card containers having one or more cards; instructions: and
a processor coupled to the display interface and the memory, wherein when executed by the processor, the computer instruction cause the electronic device to;
attempt to detect, using the display interface container, a card container selection;
detect using the card container selection and based on a current focus, a card container selection even generated upon either an up arrow button pressing even or a down arrow button pressing event;
determine, according to the card container selection event, a target card container in which a target locus is located; and
determine, as the target focus and according to a focus up movement algorithm or a focus down movement algorithm, a card in the target card container and that has a largest area adjacent to the current focus.

13.-14. (canceled)

15. The electronic device of claim 12, wherein when executed by the processor, the computer instructions further cause the electronic device to determine the card in a plurality of cards according to a preset rule when the target card container has the plurality of cards that have same areas adjacent to the current focus.

16. The electronic device of claim 15, wherein when executed by the processor, the computer instructions further cause the electronic device to determine a leftmost card in the plurality of cards as the target focus when the card container selection event is generated upon the down arrow button pressing event. Atty. Docket No. 4805-45700 (86439384US03)

17. The electronic device of claim 15, wherein when executed by the processor, the computer instructions further cause the electronic device to determine a rightmost card in the plurality of cards as the target focus when the card container selection event is generated upon the up arrow button pressing event.

18. The electronic device of claim 12, wherein when executed by the processor, the computer instructions further cause the electronic device to scroll each card container on the display interface upward such that the target card container is completely displayed in a display region of the display interface when the target card container is in a non-display region of the display interface.

19. The electronic device of claim 12, wherein when executed by the processor, the computer instructions further cause the electronic device to scroll each card container on the display interface downward such that the target card container is completely displayed in a display region of the display interface when the target card container is in a non-display region of the display interface.

20. The electronic device of claim 12, wherein when executed by the processor, the computer instructions further cause the electronic device to scroll each card container on the display interface upward such that the target card container is completely displayed in a display Atty. Docket No. 4805-45700 (86439384US03) region of the display interface when the target card container is in a partially displayed in the display region.

21. The electronic device of claim 12, wherein when executed by the processor, the computer instructions further cause the electronic device to scroll each card container on the display interface downward such that the target card container is completely displayed in a display region of the display interface when the target card container is in a partially displayed in the display region.

22. The electronic device of claim 12, wherein the one or more card containers are arranged in a column.

23. The electronic device of claim 12, wherein the one or more cards in each card container are arranged in a row.

24. The method of claim 1, wherein the display interface further comprises a display region and a non-display region, and wherein the method further comprises scrolling each card container on the display interface downward such that the target card container is completely displayed in the display region when the target card container is in the non-display region or is partially displayed in the display region.
